(19) United States
(12) Patent Application Publication
(10) Pub. No.: US 2026/0250134 A1
(43) Pub. Date: Aug. 27, 2026

(54) A METHOD FOR PRODUCING A CARBON MATERIAL FROM LIGNIN

(71) Applicant: Stora Enso OYJ, Helsinki (FI)

(72) Inventors: Abhishek Shetty, Nacka (SE); Vilhelm Olsson, Täby (SE); Mario Wachtler, Strängnäs (SE)

(73) Assignee: Stora Enso OYJ, Helsinki (FI)

(21) Appl. No.: 19/103,928

(22) PCT Filed: Aug. 17, 2023
(86) PCT No.: PCT/IB2023/058244

§ 371 Date: Feb. 14, 2025

(30) Foreign Application Priority Data
Aug. 17, 2022 (SE) 2230267-3

(51) Int. Cl. C01B 32/05; H01M 4/587

(52) U.S. Cl. CPC C01B 32/05; H01M 4/587; C01P 2006/40

(57) ABSTRACT

The present invention relates to a method for producing a carbon material, the method comprising the steps of: providing lignin, providing at least one thermoset resin, contacting lignin with the at least one thermoset resin so as to obtain a lignin-thermoset resin material, curing the lignin-thermoset resin material, and subjecting the cured lignin-thermoset resin material to heat treatment so as to obtain a carbon material. The obtained carbon material is suitable for use as active material in a negative electrode of a secondary battery.

### FIELD OF THE INVENTION

The present invention relates to a method for producing a carbon material from lignin, and a carbon material obtainable by the method. The method involves contacting lignin with a thermoset resin. The present invention further relates to a negative electrode for a secondary battery comprising said carbon material as active material. The present invention further relates to use of said carbon material as active material in a negative electrode for a secondary battery.

### BACKGROUND

Secondary batteries, such as lithium-ion batteries, are electrical batteries which can be charged and discharged many times, i.e. they are rechargeable batteries. In lithium-ion batteries, lithium ions flow from the negative electrode through the electrolyte to the positive electrode during discharge, and back when charging. Typically, a lithium compound, in particular a lithium metal oxide such as lithium nickel manganese cobalt oxide (NMC) or alternatively a lithium iron phosphate (LFP), is utilized as material of the positive electrode and a carbon enriched material is utilized as material of the negative electrode.

Graphite (natural or synthetic graphite) is today utilized as material of the negative electrode in most lithium-ion batteries. An alternative to graphite is amorphous carbon materials, such as hard carbons (non-graphitizable amorphous carbons) and soft carbons (graphitizable amorphous carbons), which lack long-range graphitic order. Amorphous carbons can be used as sole active electrode materials or in mixtures with graphite (and/or other active materials).

Amorphous carbons can be derived from lignin. Lignin is an aromatic polymer, which is a major constituent in e.g. wood and one of the most abundant carbon sources on earth. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry. Amorphous carbons derived from lignin are typically non-graphitizable, i.e. hard carbons.

Lignin has a complex chemical structure which depends largely on its origin, such as the type of plant or tree from which the lignin is obtained. The properties of lignin, such as its glass transition temperature, vary significantly depending on the chemical structure, the composition of the lignin as well as any impurities present. In particular, lignin obtained from hardwood, such as Eucalyptus, has a relatively lower glass transition temperature than lignin obtained from softwood.

Today, the most commercially relevant source of lignin is kraft lignin, obtained from hardwood or softwood through the kraft process. The lignin can be separated from alkaline black liquor using for example membrane-or ultrafiltration. One common separation process is described in WO2006031175 A1. In this process lignin is precipitated from alkaline black liquor by reducing the pH level of the black liquor, usually by adding carbon dioxide, and then filtered off. The lignin filter cake is in the next step re-slurried under acidic conditions, commonly using sulfuric acid, and washed. The precipitated washed lignin can be used as it is or further dried.

One problem with using lignin as a precursor for a carbon enriched material is that direct use of lignin, in the form of a fine powder, is not suitable since it exhibits undesired thermoplastic behavior, as well as a strong tendency for dust formation. During thermal conversion of lignin powder into carbon enriched materials, lignin undergoes plastic deformation/melting, aggressive swelling and foaming. This severely limits the processability of lignin in an industrially relevant scale, in terms of equipment dimensioning and process throughput as well as need of intermediate processing. In addition, dust formation increases the risk for dust explosions during processing.

The problems described above regarding undesired thermoplastic behaviour are particularly pronounced when processing lignin having a low glass transition temperature, such as lignin obtained from hardwood. For lignin having a low glass transition temperature, the problems related to melting, softening and decomposition will begin at a relatively lower temperature.

Thus, there is still room for improvements of methods for producing a carbon enriched material from lignin, regardless of the source of the lignin. The method should avoid that lignin undergoes plastic deformation/melting, aggressive swelling and foaming during any heating steps, as well as when converting the lignin to a carbon enriched material. The method should also avoid dust formation during processing of lignin. In addition, it should be possible to use the method in large-scale manufacturing.

### SUMMARY OF THE INVENTION

It is an object of the present invention to provide an improved method for producing a carbon enriched material, which method allows use of a renewable carbon source, and which method eliminates or alleviates at least some of the disadvantages of the prior art methods.

It is a further object of the present invention to provide a method that obtains an improved carbon enriched material starting from lignin, which carbon enriched material is suitable for use as active material in a negative electrode of a secondary battery, such as a lithium-ion battery.

It is a further object of the present invention to provide a method for producing a carbon enriched material from lignin, which method allows heat treatment of lignin, regardless of the origin of the lignin, with retained shape.

It is a further object of the present invention to provide a method for avoiding dust formation during processing of lignin in powder form.

It is a further object of the present invention to provide a method for producing a carbon enriched material from lignin, which method is scalable and thus suitable for large-scale manufacturing.

The above-mentioned object, as well as other objects as will be realized by the skilled person in light of the present disclosure, are achieved by the various aspects of the present disclosure.

According to a first aspect, the present invention relates to a method for producing a carbon material from lignin, the method comprising the steps of:
a) providing lignin;
b) providing at least one thermoset resin;
c) contacting the lignin with the at least one thermoset resin so as to obtain a lignin-thermoset resin material;
d) optionally drying the lignin-thermoset resin material;
e) curing the lignin-thermoset resin material or the dried lignin-thermoset resin material so as to obtain a cured lignin-thermoset resin material; and
f) subjecting the cured lignin-thermoset resin material to heat treatment at one or more temperatures in the range of from 300° C. to 3000° C., wherein the heat treatment is carried out for a total time in the range of from 30 minutes to 10 hours, so as to obtain a carbon material.

It has surprisingly been found that by contacting lignin with a thermoset resin, a lignin-thermoset resin material that after curing can be heat treated with retained shape, avoiding melting/swelling and deformation, is obtained. The dust formation during processing of lignin is also reduced by the inventive method. The contacting of lignin with the thermoset resin may be performed for example by coating the lignin with the thermoset resin or by mixing the lignin with the thermoset resin. The lignin-thermoset resin material can thus be converted to a carbon enriched material while retaining its shape. Surprisingly, the inventive method also facilitates thermal processing of lignin having a low glass transition temperature, such as lignin obtained from hardwood.

According to a second aspect, the present invention relates to a carbon material obtainable by the method according to the first aspect.

It has surprisingly been found that when converting a lignin-thermoset resin material to a carbon enriched material by heat treatment, the shape of the lignin-thermoset resin material is maintained during the heat treatment. The resulting carbon material is suitable for use in for example energy storage applications, such as active material in a negative electrode of a secondary battery.

According to a third aspect, the present invention relates to a negative electrode of secondary battery comprising the carbon material obtainable by the method according to the first aspect as active material.

According to a fourth aspect, the present invention relates to use of the carbon material obtainable by the method according to the first aspect as active material in a negative electrode of a secondary battery.

### DETAILED DESCRIPTION

Step a) of the method according to the first aspect involves providing lignin. It is intended throughout the present disclosure that the term “lignin” refers to any kind of lignin which may be used as the carbon source for making a carbon material.

Examples of said lignin are, but are not limited to, lignin obtained from vegetable raw material such as wood, e.g. softwood lignin, hardwood lignin, and lignin from annular plants. Also, the lignin can be chemically modified.

Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%, more preferably at least 98%, based on the dry weight of the lignin material. Thus, the lignin material used according to the process of the present invention preferably contains less than 10%, preferably less than 5%, more preferably less than 2% impurities, such as cellulose, carbohydrates and inorganic compounds, based on the dry weight of the lignin material.

The lignin may be obtained through different extraction methods such as an organosolv process or a kraft process. Preferably, the lignin used in the method of the present invention is kraft lignin, i.e. lignin obtained through the kraft process. The kraft lignin may be obtained from hardwood or softwood.

Kraft lignin is readily available as a by-product from pulp production by the kraft process. Utilizing kraft lignin that would otherwise typically be discarded is beneficial from a sustainability point of view. Thus, by utilizing kraft lignin, a more sustainable method is enabled. Kraft lignin can be extracted on an industrial scale by well-known and established processes that result in lignin with consistent quality. Kraft lignin is therefore suitable to use in large-scale processing where the repeatability of the process is of high importance. The extracted kraft lignin can readily be chemically modified or cross-linked which facilitates further processing.

The lignin may be obtained by the process disclosed in WO2006031175 A1 commonly referred to as the LignoBoost process. Typically, this process involves the steps of: precipitation of lignin from alkaline black liquor by acidification; separation of the precipitated lignin; and re-slurrying the lignin under acidic conditions at least once. The obtained lignin may be dried and pulverized and thus provided as solid particles.

Preferably, the lignin provided in step a) of the method according to the first aspect is in the form of a powder, agglomerated lignin, a shaped body, or a liquid solution. In some embodiments, the lignin provided in step a) is in the form of a powder, agglomerated lignin or a shaped body. In such embodiments, the lignin provided in step a) is preferably in dry form. Providing lignin in dry form is advantageous since subsequent isolation and drying steps are not needed, and solvents are not needed. Processing is thus facilitated.

In some embodiments, the lignin provided in step a) is in the form of a powder. The particle size distribution of the lignin in the form of a powder may be such that at least 80 wt % of the particles have a diameter less than 0.2 mm. The lignin powder may also have a moisture content of less than 45 wt %. Lignin in the form of a powder is readily available e.g. from the LignoBoost process, and a method using lignin powder as the starting material thus requires no additional processing steps for preparation of the starting material. The lignin powder may also be provided in the form of a slurry, that is that the lignin powder is mixed with a solvent, preferably water.

In the context of the present invention, the diameter of a particle is the equivalent spherical diameter of the particle, if the particle is not spherical. The equivalent spherical diameter is the diameter of a sphere of equivalent volume.

In some embodiments, the lignin provided in step a) is in the form of agglomerated lignin. The agglomerated lignin may have a particle size distribution such that at least 80 wt-% of the agglomerates have a diameter within the range of from 0.2 mm to 5.0 mm. One method for obtaining such agglomerated lignin is described in WO2020183383 A1.

Briefly, purified, and preferably dried, lignin powder is compacted, and the compacted lignin is crushed to obtain agglomerated lignin. The compaction of the lignin is preferably carried out by roll compaction. In the compaction step, an intermediate product is generated. Here, the fine lignin powder is usually fed through a hopper and conveyed by means of a horizontal or vertical feeding screw into the compaction zone where the material is compacted into flakes by compaction rollers with a defined gap. By controlling the feeding screw speed, the pressure development in the compaction zone, flakes with uniform density can be obtained. The pressure development in the compaction zone can preferably be monitored and controlled by the rotational speed of the compaction rolls. As the powder is dragged between the rollers, it enters what is termed as the nip area where the density of the material is increased, and the powder is converted into a flake or ribbon. The rolls used have cavities. The depth of each cavity used in the roll compaction is from 0.1 mm to 10 mm, preferably from 1 mm to 8 mm, more preferably from 1 mm to 5 mm or from 1 mm to 3 mm. The specific press force exerted during the compaction may vary depending on the equipment used for compaction, but may be in the range of from 1 kN/cm to 100 kN/cm. Equipment suitable for carrying out the compaction is known in the art.

In the crushing step, the intermediate product from the compaction step is subjected to crushing or grinding, such as by means of a rotary granulator, cage mill, beater mill, hammer mill or crusher mill and/or combinations thereof. During this step, a further intermediate product is generated.

After crushing, the crushed material is preferably subjected to a sieving step, to remove fine material. In addition, large material, such as agglomerates having a diameter larger than 5.0 mm, may be removed and/or recirculated back to the crushing step.

The agglomeration of lignin results in an agglomerated lignin having improved thermal properties, such as a reduced tendency for melting/foaming and deformation during heating. The tendency for dust formation during processing is also reduced by the agglomeration process. Thus, in embodiments where the lignin is provided in the form of agglomerated lignin, the ability of the lignin-thermoset resin material to retain its shape during thermal processing is improved by a combination of lignin being in agglomerated form and the presence of a thermoset resin.

In some embodiments, the lignin provided in step a) is in the form of a shaped body. The term “shaped body” as used herein, refers to a solid lignin body that has been formed into a certain shape by thermal processing or casting of lignin. Non-limiting examples of such a shaped body is a pellet, a granule, a sheet, a fiber, a rod, a bar, a tablet etc. The size and dimension of the shaped body is not limited. The inventive method can thus be applied to objects of various sizes and shapes.

In some embodiments, the lignin provided in step a) is in the form of a liquid solution. Lignin may be dissolved in any suitable solvent(s) to form the liquid solution, such that the liquid solution comprises dissolved lignin and at least one solvent. The solvent may be for example an alkaline aqueous solution, a polar protic solvent, such as dimethyl sulfoxide or dimethyltryptamine, or a polar aprotic solvent, such as an alcohol or an amine. The lignin may also be dissolved in a polymer melt. The amount of lignin in the liquid solution is preferably in the range of from 10 to 95 wt %, such as from 10 to 70 wt %, or from 10 to 50 wt % or from 10 to 30 wt %, based on the total weight of the liquid solution. By providing lignin in the form of a liquid solution, subsequent contacting with a thermoset resin may be facilitated, in particular in embodiments where the thermoset resin is provided in liquid form. In some embodiments, the liquid solution comprises more than one solvent.

Step b) of the method according to the first aspect involves providing at least one thermoset resin. The term “thermoset resin” as used herein, refers to a resin that is irreversibly hardened by curing. The term “thermoset resin” is not intended to cover precursors of thermoset resins, but only the resin obtained by reaction of one or several precursors.

The type of thermoset resin is not particularly limited, and any suitable thermoset resin can be used in the method according to the present invention. In some embodiments, the at least one thermoset resin may be selected from the group of: furan resins, such as polyfurfuryl alcohol, epoxy-based resins, phenolic resins, such as bakelite, vinyl esters, melamine resins and polyimides. Preferably, the thermoset resin is a furan resin, such as polyfurfuryl alcohol.

Preferably, the at least one thermoset resin is provided in solid form and/or in liquid form. For example, if more than one thermoset resin is provided, one may be in solid form and one in liquid form.

In some embodiments, the at least one thermoset resin is provided in liquid form. Optionally, the thermoset resin in liquid form may be diluted using a solvent. Dilution of the liquid thermoset resin is preferably carried out if the thermoset resin has a high viscosity, in order to facilitate the subsequent contacting step. By providing the thermoset resin in liquid form, after contacting lignin with the thermoset resin, the tendency for dust formation during processing of the lignin is reduced and handling is facilitated.

In some embodiments, the at least one thermoset resin is provided in solid form, such as in the form of a powder. By providing the thermoset resin in solid form, the process of mixing the thermoset resin with a lignin powder is facilitated. Dry mixing is advantageous from a cost perspective since solvents are not needed, and since fewer process steps are required since isolation and drying of lignin and/or thermoset resin is not required.

In some embodiments, one thermoset resin is provided in step b). In some embodiments, more than one thermoset resin is provided in step b), such as two different types of thermoset resins, or three different types of thermoset resins. The different types of thermoset resins may also be in different form, such as at least one being in liquid form and at least one being in solid form.

Step c) of the method according to the first aspect involves contacting the lignin with the at least one thermoset resin so as to obtain a lignin-thermoset resin material.

The term “lignin-thermoset resin material” as used herein, refers to a material comprising both lignin and at least one thermoset resin. The lignin-thermoset resin material may optionally comprise at least one additive. The lignin may be e.g. coated or impregnated with the thermoset resin, or the lignin and the thermoset resin may form a mixture.

The lignin-thermoset resin material of the present invention is a composite material comprising lignin and at least one thermoset resin. Lignin is contacted with a thermoset resin, and not with precursors of a thermoset resin. Thus, the lignin-thermoset resin material of the present invention is not a lignin-based thermoset resin. Such a lignin-based thermoset resin would be obtained for example if lignin were reacted with precursors of a thermoset resin. In the present invention, lignin is not modified by being contacted with the thermoset resin and there are no changes to the main polymeric structure of lignin.

In one embodiment, the total amount of thermoset resin in the lignin-thermoset resin material is in the range of from 1 wt % to 70 wt %, such as from 1 wt % to 50 wt %, or from 1 wt % to 20 wt %, or from 1 wt % to 10 wt %, based on the total dry weight of the lignin-thermoset resin material. By “total amount of thermoset resin” is meant the total amount of all thermoset resins present in the lignin-thermoset resin material.

In a preferred embodiment, the total amount of thermoset resin in the lignin-thermoset resin material is in the range of from 1 wt % to 20 wt %, or from 1 wt % to 10 wt %, or from 1 wt % to 5 wt %, based on the total weight of the lignin-thermoset resin material. It is advantageous to form a lignin-thermoset resin material comprising low amounts of thermoset resin since the material in that case comprises mainly material from a renewable resource, enabling a more sustainable method. The cost of lignin is also typically lower than the cost of thermoset resin. Low amounts of thermoset resin, such as from 1 wt % to 5 wt %, based on the total weight of the lignin-thermoset resin material, will improve the thermal properties of the material sufficiently so as to avoid melting/swelling of lignin during heat treatment.

In some embodiments, the thermoset resin(s) may be derived from renewable sources. In such embodiments, the lignin-thermoset resin material may be entirely renewable.

The lignin-thermoset resin material comprises from 30 to 99 wt %, or from 50 to 99 wt %, or from 80 to 99 wt %, or from 90 to 99 wt % lignin, based on the total weight of the lignin-thermoset resin material. Preferably, the lignin-thermoset resin material comprises from 80 to 99 wt %, or from 90 to 99 wt %, or from 95 to 99 wt % lignin, based on the total weight of the lignin-thermoset resin material.

The lignin-thermoset resin material may comprise only lignin and thermoset resin, or may comprise lignin, thermoset resin and at least one additive. The amount of the at least one additive is typically small, such as below 5 wt %, or below 2 wt %, as based on the total weight of the lignin-thermoset resin material.

The term “contacting” as used herein, refers to the process of putting lignin and at least one thermoset resin in close proximity to each other, such as by coating or mixing. In some embodiments, there are no, or essentially no, chemical reactions occurring between lignin and the at least one thermoset resin in the contacting step. In other embodiments, some chemical reactions may occur between the thermoset resin and reactive sites of lignin in the contacting step.

In preferred embodiments of the present invention the lignin-thermoset resin material comprises from 80 to 99 wt %, or from 90 to 99 wt %, or from 95 to 99 wt % lignin, based on the total weight of the lignin-thermoset resin material. In such embodiments, the amount of lignin is always considerably higher than the amount of thermoset resin in the contacting step. Thus, if some chemical reactions occur between the thermoset resin and lignin, only a minor portion of the lignin within the lignin-thermoset resin material will have reacted whereas a major portion of the lignin will remain unaltered by the contacting step.

In some embodiments, the step of contacting involves coating or impregnating the lignin with the at least one thermoset resin. In such embodiments, the thermoset resin is preferably in liquid form, and the lignin is preferably in solid form, i.e. in the form of a powder, in the form of agglomerated lignin or in the form of a shaped body. Any suitable methods as known by a person skilled in the art can be used, for example spray coating or dip coating. By coating or impregnating lignin with the thermoset resin, an outer layer of thermoset resin is obtained on the solid lignin. After curing, this provides the solid lignin with a hard, protective layer which reduces the formation of dust, as well as any tendencies for individual particles of solid lignin to stick together due to melting/softening of the surface during the subsequent heat treatments.

In some embodiments, contacting involves mixing lignin and the at least one thermoset resin. In such embodiments, the thermoset resin may be in the form of a liquid or solid, and the lignin may be in the form of a powder, in the form of agglomerated lignin, in the form of a shaped body or in the form of a liquid solution. Mixing can be performed using any method as known by a person skilled in the art. Both dry mixing and wet mixing methods can be used. One example of a suitable method is a vertical mixer, such as paddle, screw or ribbon-screw mixer in a batch or continuous mode. The mixing process may be carried out in a low-, medium-or high-shear impact mode.

In embodiments where at least one thermoset resin is provided in the form of a liquid and lignin is provided in dry form, lignin is not dissolved, or only dissolved to a minor extent, in the thermoset resin.

In some embodiments, a solvent is present during the step of contacting. The presence of a solvent may facilitate the contacting between the lignin and the thermoset resin, and may also facilitate further processing steps, such as forming of the lignin-thermoset resin material. Any suitable solvent for the thermoset resin may be used, such as water, tetrahydrofuran or dichloromethane. The solvent may be added prior to contacting, such as to the thermoset resin, or during the contacting, such as during mixing. In embodiments where lignin is provided in the form of a liquid solution, the solvent may be added to the liquid solution comprising dissolved lignin.

The lignin-thermoset resin material may optionally comprise an additive. Any suitable additives, such as binders or lubricants, may be added to facilitate any subsequent forming or agglomeration processes and/or to improve the density and mechanical properties of the lignin-thermoset resin material. In addition, additives having an influence on the properties of the final carbon material may be added, such as functionality-enhancing additives. The total amount of additive(s) is preferably less than 5 wt %, such as less than 2 wt %, as based on the total dry weight of the additive and lignin-thermoset resin material. In one embodiment, the additive is added to the lignin-thermoset resin material prior to curing of the lignin-thermoset resin material. The additive may also be added to the lignin and/or to the thermoset resin prior to contacting the lignin with the thermoset resin.

In some embodiments, the method according to the first aspect comprises an additional step of forming the obtained lignin-thermoset resin material prior to curing. Forming may be carried out by at least one means selected from the group of casting, pressing, pelletizing, kneading, granulating and extruding the lignin-thermoset resin material. The size and shape of the formed lignin-thermoset resin material varies depending on the means used for forming. The type, amount and form of the at least one thermoset resin provided in step b), may be selected depending on the means used for forming the lignin-thermoset resin material. The forming means may also influence the selection of thermoset resin. By carrying out the contacting in step c) in the presence of a solvent, subsequent forming of the lignin-thermoset resin material may be facilitated. By forming the lignin-thermoset resin material, subsequent processing may be facilitated. Depending on the type of furnace used in the process, different shapes of the lignin-thermoset resin materials are preferred. For rotary furnaces small granules or pellets are useful. For batch production furnaces, it is preferred that the lignin-thermoset resin material is in the shape of cylinders or bricks.

In some embodiments, the formed lignin-thermoset resin material may be crushed or milled prior to subsequent processing steps so as to reduce the size of the formed lignin-thermoset resin material. Crushing or milling of the formed lignin-thermoset resin material is preferably carried out when forming means such as casting, pressing or kneading, that results in the formation of large coherent pieces of lignin-thermoset resin material, are used. To facilitate further processing into a carbon material, the large pieces are preferably crushed or milled. Crushing or milling may be carried out after curing of the lignin-thermoset resin material, or after partial curing of the lignin-thermoset resin material. If crushing or milling is carried out after partial curing, additional curing may be carried out after the crushing or milling. Crushing or milling can be carried out using any suitable means as known by a person skilled in the art.

Step d) of the method according to the first aspect involves optionally drying the obtained lignin-thermoset resin material. Drying may be performed at room temperature and/or at an elevated temperature. Drying may be performed using any suitable means as known by a person skilled in the art. Drying may be performed under ambient pressure, reduced pressure, or vacuum. In some embodiments, drying is performed at room temperature for at least 10 hours. In some embodiments, drying is performed at one or more temperatures below 60° C., such as in the range of from 30° C. to 60° C., for a time period in the range of from 5 minutes to 10 hours. After drying, the dry content of the lignin-thermoset resin material is at least 50 wt %, such as at least 70 wt %, or at least 80 wt %. The drying step is of particular importance in embodiments where the thermoset resin has been diluted with a solvent, in order to remove the solvent.

Step e) of the method according to the first aspect involves curing the lignin-thermoset resin material or the dried lignin-thermoset resin material so as to obtain a cured lignin-thermoset resin material. Curing may be carried out at room temperature and/or at an elevated temperature. By increasing the temperature, the curing becomes faster. The temperature required for curing also depends on the type of thermoset resin.

In some embodiments, curing is carried out at one or more temperatures in the range of from 20° C. to 250° C., such as from 20° C. to 200° C., or 20° C. to 150° C., or 50° C. to 150° C. for a total time of at least 30 minutes, i.e. the residence time of the lignin-thermoset resin material inside the equipment used for the curing is at least 30 minutes. The total time for curing is preferably less than 24 hours. During curing, irreversible hardening of the at least one thermoset resin occurs. After curing, a lignin-thermoset resin material that does not change its shape during the subsequent heat treatment is obtained. Also, addition of the thermoset resin to lignin reduces the melting/swelling behaviour of lignin during heating.

In preferred embodiments curing is carried out at one or more temperatures in the range of from 20° C. to 150° C., or 50° C. to 150° C. for a total time of at least 30 minutes. In such embodiments, lignin exhibits no, or only minor, melting/swelling behaviour.

In embodiments where lignin is coated or impregnated with the at least one thermoset resin, it is believed by the present inventors that after curing the hardened thermoset resin will retain the lignin within the lignin-thermoset resin material so that melting/swelling of lignin is prevented during any subsequent heat treatment at temperatures where lignin would normally exhibit melting/swelling behaviour.

In embodiments where lignin is mixed with the at least one thermoset resin, it is believed that a matrix of thermoset resin may be formed after curing, with lignin being contained within the matrix so that melting/swelling of lignin is prevented during any subsequent heat treatment at temperatures where lignin would normally exhibit melting/swelling behaviour.

In some embodiments, lignin may react with the thermoset resin during curing. In other embodiments, the only reactions that occur during curing is within the thermoset resin. In some embodiments there will be reactions between lignin polymer chains during curing. Thus, during curing there will be cross-linking reactions occurring within the thermoset resin and there may also be cross-linking reactions between the thermoset resin and lignin, and/or between different lignin polymer chains. Cross-linking reactions between lignin and thermoset resin as well as between different lignin polymer chains will reduce the melting/swelling behaviour of lignin during any subsequent heating steps at temperatures where lignin would normally exhibit melting/swelling behaviour. Cross-linking within the thermoset resin may create physical restrains that prevents melting/swelling of lignin.

Which reactions, apart from cross-linking of the thermoset resin, that occur during curing depends on for example the temperature and the type of thermoset resin used.

In some embodiments, curing is carried out using the same temperature throughout the entire curing step. For example, curing may be carried out at room temperature for a total time of at least 30 minutes.

In some embodiments, curing is carried out at varying temperature, such as using a stepwise increase of the temperature or using a temperature gradient. In some embodiments, the curing is carried out in several steps at different temperatures. The temperature may be increased from one step to the subsequent step by a temperature ramp or gradient. For example, the curing may be carried out by heating the lignin-thermoset resin material to a first temperature in the range of from 20° C. to 250° C., such as from 20° C. to 200° C., or 20° C. to 150° C., or 50° C. to 150° C., followed by heating to a second temperature in the range of from 20° C. to 250° C., such as from 20° C. to 200° C., or 20° C. to 150° C., or 50° C. to 150° C., and so on, and holding at each selected temperature for a certain amount of time, such as in the range of from 10 minutes to 3 hours. By carrying out the curing in several steps at different temperatures, an improved crosslinking of the cured lignin-thermoset resin material is achieved. In addition, the risk of cracking of the lignin-thermoset resin material during curing is decreased as the curing process can be carried out in a more controlled fashion.

In some embodiments, curing is directly followed by heat treatment. For example, curing may first be carried out at one or more temperatures in the range of from 20° C. to 250° C., such as from 20° C. to 200° C., or 20° C. to 150° C., or 50° C. to 150° C., and the temperature may then be increased to the temperatures employed during the heat treatment. The increase in temperature may be stepwise or may comprise a temperature ramp. The curing may thus in some embodiments be carried out in the same reactor as the subsequent heat treatment.

In some embodiments, an acidic catalyst is added to the at least one thermoset resin material provided in step b), and the curing of the lignin-thermoset resin material in step e) is catalysed by the acidic catalyst. The acidic catalyst may be selected from sulfuric acid, maleic anhydride or p-toluene sulfonic acid. Curing using a catalyst can be carried out at room temperature and/or at an elevated temperature. The curing is faster at an elevated temperature.

Curing may be achieved using both a catalyst and an elevated temperature, or by only a catalyst, or by only an elevated temperature.

If the lignin-thermoset resin material has not been dried prior to curing at an elevated temperature, drying may occur simultaneously with curing.

Preferably, the method comprises an additional step of milling the cured lignin-thermoset resin material. Milling is performed so that the average particle size is reduced. Milling may also be carried out on the carbon material obtained after heat treatment of the cured lignin-thermoset resin material. Milling may be carried out by methods such as impact milling, hammer milling, ball milling and jet milling.

Optionally, fine/coarse particle selection by classification and/or sieving may be carried out subsequent to the milling.

The method according to the first aspect may involve several milling steps. For example, if the lignin-thermoset resin material has been formed into large coherent pieces, a first step of crushing or milling may be followed by subsequent milling steps. Milling may also be carried out both after curing and after heat treatment.

Step f) of the method according to the first aspect involves subjecting the cured lignin-thermoset resin material to heat treatment at one or more temperatures in the range of from 300° C. to 3000° C. The heat treatment is carried out for a total time in the range of from 30 minutes to 10 hours, i.e. the residence time of the lignin-thermoset resin material inside the equipment used for the heat treatment is in the range of from 30 minutes to 10 hours, so as to obtain a carbon material.

The term “heat treatment” as used herein, refers to a process of heating the lignin-thermoset resin material at one or more temperatures and for a sufficient amount of time so that the carbon content of the lignin-thermoset resin material is increased, and so that the lignin-thermoset resin material is converted to a carbon material.

Depending on the temperature during the heat treatment, different types of carbon materials, such as charcoal or hard carbon, can be obtained from the lignin-thermoset resin material.

The terms “carbon material” and “carbon enriched material” are both used herein to denote a material consisting largely, such as at least 80 wt %, or at least 90 wt %, or at least 95 wt %, of carbon, and obtained by carbonization of an organic compound.

The heat treatment may be carried out at the same temperature throughout the entire heat treatment or may be carried out at varying temperature, such as a stepwise increase of the temperature or using a temperature gradient. The heat treatment may comprise a temperature ramp from a starting temperature to a target temperature. The heating rate may be 1-100° C./min. For example, the heat treatment may involve several intermediate temperatures, with temperature ramps in between them, before reaching the target temperature needed for carbonization of the lignin-thermoset resin material. The heat treatment may be carried out as a batch process or a continuous process. Any suitable reactor can be used, such as rotary kiln, moving bed furnace, pusher furnace or rotary hearth furnace. The heat treatment is preferably carried out under inert atmosphere, preferably nitrogen atmosphere.

Preferably, the heat treatment comprises a preliminary heating step, preferably followed by a final heating step. The preliminary heating step is preferably carried out at one or more temperatures in the range of from 300° C. to 800° C., such as from 500° C. to 700° C. The preliminary heating step is preferably carried out under inert atmosphere, preferably nitrogen atmosphere. The duration of the preliminary heating step is at least 30 minutes and preferably less than 10 hours. The surface area of the carbon material obtained after the preliminary heating step is typically in the range of from 300 to 700m²/g, measured as BET using nitrogen gas.

The final heating step is preferably carried out at one or more temperatures in the range of from 800° C. to 3000° C. The final heating step is preferably carried out under inert atmosphere, preferably nitrogen atmosphere. The duration of the final heating step is at least 30 minutes and preferably less than 10 hours. After the final heating step carried out at 1000° C. or higher, the surface area of the obtained carbon material is typically 50m²/g or less.

The preliminary and final heating steps may be carried out as discrete steps or as one single step in direct sequence. The preliminary and final heating steps may involve heating at one or more temperatures, as discussed above for the heat treatment. For example, the preliminary heating starts at about 300° C. and the temperature is subsequently increased to about 500° C. The final heating step is preferably carried out between 900° C. and 1300° C., such as at about 1000° C.

The preliminary and final heating steps may be carried out as batch processes or as continuous processes. Any suitable reactors can be used, such as rotary kiln, moving bed furnace, pusher furnace or rotary hearth furnace. The preliminary heating step and the final heating step can be carried out in the same reactor or in separate reactors.

If milling is carried out, it may be carried out in between the preliminary heating step and the final heating step, or after the final heating step.

After heat treatment, the obtained carbon may undergo further processing, such as e.g. carbon-coating by chemical vapor deposition (CVD), pitch coating, thermal and/or chemical purification, further heat treatment(s), particle size adjustment, and blending with other electrode materials to e.g. further improve its electrochemical performance.

According to a second aspect, the present invention relates to a carbon material obtainable by the method according to the first aspect. The carbon material obtainable by the method according to the first aspect is suitable for use in for example energy storage applications, such as active material in a negative electrode of a secondary battery. The carbon material according to the second aspect may be further defined as set out above with reference to the first aspect.

The carbon material obtainable by the method according to the first aspect is preferably used as an active material in a negative electrode of a non-aqueous secondary battery, such as a lithium-ion battery. When used for producing such a negative electrode, any suitable method to form such a negative electrode may be utilized. In the formation of the negative electrode, the carbon enriched material may be processed together with further components. Such further components may include, for example, one or more binders to form the carbon enriched material into an electrode, conductive materials, such as carbon black, carbon nanotubes or metal powders, and/or further Li storage materials, such as graphite or lithium. For example, the binders may be selected from, but are not limited to, poly(vinylidene fluoride), poly(tetrafluoroethylene), carboxymethylcellulose, natural butadiene rubber, synthetic butadiene rubber, polyacrylate, poly(acrylic acid), alginate, etc., or from combinations thereof. Optionally, a solvent such as e.g. 1-methyl-2-pyrrolidone, 1-ethyl-2-pyrrolidone, water, or acetone is utilized during the processing.

According to a third aspect, the present invention relates to a negative electrode of a secondary battery comprising the carbon material obtainable by the method according to the first aspect as active material. The carbon material of the negative electrode according to the third aspect may be further defined as set out above with reference to the first aspect.

According to a fourth aspect, the present invention relates to use of the carbon material obtainable by the method according to the first aspect as active material in a negative electrode of a secondary battery. The carbon material of the fourth aspect may be further defined as set out above with reference to the first aspect.

### EXAMPLES

### Example 1

Softwood or hardwood lignin powder obtained from the LignoBoost process was mixed with liquid polyfurfuryl alcohol so that a mixture was obtained. The amount of polyfurfuryl alcohol added was 10 wt % based on the dry weight of lignin. Water (25 wt % based on the amount of polyfurfuryl alcohol) was added to the mixture to form a dough-like material. The dough-like material was casted or pelletized into smaller objects, that were dried at room temperature for 12 hours. After drying, curing was carried out in a stepwise sequence where the material was heated at 50° C. for 1 hour, at 70° C. for 1 hour, at 90° C. for 1 hour and at 150° C. for 1 hour. The material gradually darkened during the curing process. After curing, the smaller objects were crushed and milled to a particle size in the range of from 0.5 mm to 2 mm. After crushing and milling, the material was carbonized at temperatures in the range of from 500° C. to 1400° C. under inert atmosphere. For both lignin obtained from hardwood and softwood, no melting, fusing or swelling was observed during heat treatments, and the material retained its shape after carbonization.

### Example 2

Softwood or hardwood lignin powder obtained from the LignoBoost process was mixed with bakelite powder or frozen and pulverized polyfurfuryl alcohol so that a mixture was obtained. The amount of resin (e.g. bakelite or polyfurfuryl alcohol) added was 10 wt % based on the dry weight of lignin. A homogenous mixture of the two powders (e.g. lignin and resin) were obtained. The powder mixtures were pressed into a large body or pellets. After pressing, curing was carried out in a stepwise sequence where the material was heated at 50° C. for 1 hour, at 70° C. for 1 hour, at 90° C. for 1 hour and at 150° C. for 1 hour. The material gradually darkened during the curing process. After curing, the bodies or pellets were crushed and milled to a particle size in the range of from 0.5 mm to 2 mm. After crushing and milling, the material was carbonized at temperatures in the range of from 500° C. to 1400° C. under inert atmosphere. For both lignin obtained from hardwood and softwood, no melting, fusing or swelling was observed during heat treatments, and the material retained its shape after carbonization.

### Example 3—Comparative

Softwood or hardwood lignin powder obtained from the LignoBoost process was carbonized at temperatures in the range of from 500° C. to 1400° C. under inert atmosphere. The lignin powder melted and foamed during carbonization, and after carbonization a single foam-like solid body was obtained.

In view of the above detailed description of the present invention, other modifications and variations will become apparent to those skilled in the art. However, it should be apparent that such other modifications and variations may be effected without departing from the spirit and scope of the invention.

1. A method for producing a carbon material from lignin, the method comprising the steps of:
a) providing lignin;
b) providing at least one thermoset resin;
c) contacting the lignin with the at least one thermoset resin so as to obtain a lignin-thermoset resin material;
d) optionally drying the lignin-thermoset resin material;
e) curing the lignin-thermoset resin material or the dried lignin-thermoset resin material so as to obtain a cured lignin-thermoset resin material; and
f) subjecting the cured lignin-thermoset resin material to a heat treatment at one or more temperatures in the a range of from 300° C. to 3000° C., wherein the heat treatment is carried out for a total time in a range of from 30 minutes to 10 hours, so as to obtain a carbon material.

2. The method according to claim 1, wherein the lignin provided in step a) is kraft lignin.

3. The method according to claim 1, wherein the lignin provided in step a) comprises a powder, an agglomerated lignin, a shaped body, or a liquid solution.

4. The method according to claim 1, wherein the at least one thermoset resin is selected from a group consisting of: furan resins, epoxy based resins, phenolic resins, melamine resins, and polyimides.

5. The method according to claim 1, wherein the at least one thermoset resin is provided in solid form, in liquid form, or in a combination thereof.

6. The method according to claim 1, wherein the a total amount of thermoset resin in the lignin-thermoset resin material is in a range of from 1 to 70 wt %, based on a total dry weight of the lignin-thermoset resin material.

7. The method according to claim 1, wherein the step of contacting involves coating or impregnating lignin with the at least one thermoset resin.

8. The method according to claim 1, wherein the step of contacting comprises mixing the lignin and the at least one thermoset resin.

9. The method according to claim 1, wherein a solvent is present during the step of contacting.

10. The method according to claim 1, further comprising a step of:
forming the lignin-thermoset resin material prior to curing.

11. The method according to claim 10, wherein the step of forming the lignin-thermoset resin material is carried out by at least one process selected from a group consisting of: casting, pressing, pelletizing, kneading, granulating, and extruding.

12. The method according to claim 1, wherein the curing is carried out at one or more temperatures in a range of from 20° C. to 250° C. for a total time of at least 30 minutes.

13. The method according to claim 1, wherein an acidic catalyst is added to the at least one thermoset resin provided in step b), and wherein the curing of the lignin-thermoset resin material in step e) is catalysed by the acidic catalyst.

14. The method according to claim 1, wherein further comprising a step of:
milling the cured lignin-thermoset resin material.

15. The method according to claim 1, wherein the heat treatment in step f) comprises a preliminary heating step, followed by a final heating step.

16. The method according to claim 15, wherein the preliminary heating step is carried out at one or more temperatures in a range of from 400°° C. to 800°° C. for at least 30 minutes.

17. The method according to claim 15, wherein the preliminary heating step is carried out in an inert atmosphere.

18. The method according to claim 15, wherein the final heating step is carried out at one or more temperatures in the a range of from 800° C. to 3000° C. for at least 30 minutes.

19. The method according to claim 15, wherein the final heating step is carried out in an inert atmosphere.

20. A carbon material obtained by the method according to claim 1.

21. A negative electrode for a secondary battery comprising:
the carbon material obtained by the method according to claim 1 as an active material.

22. (canceled)
